(19) United States
(12) Patent Application Publication
(10) Pub. No.: US 2012/0032398 A1
(43) Pub. Date: Feb. 9, 2012

(54) Game Piece Having A Pealable Overlay

(75) Inventors: Bill Gillespie, Tampa, FL (US); Steven W. Richter, Tampa, FL (US)

(73) Assignee: Promo Printing Group, Inc., Tampa, FL (US)

(21) Appl. No.: 13/276,468

(22) Filed: Oct. 19, 2011

Related U.S. Application Data
(62) Division of application No. 12/411,580, filed on Mar. 26, 2009.

(51) Int. Cl. B42D 15/00

(52) U.S. Cl. 273/288; 283/101

(57) ABSTRACT

A game piece overlay including a transparent base sheet and an opaque top sheet coextensive with the base sheet. The transparent base sheet has a top surface and a bottom surface that is non-releasably adhered to a surface of a game piece to overlay and conceal an underlying printed message by a transparent pressure sensitive adhesive applied to the bottom surface. The top sheet includes a non-peel portion non-releasably bonded to the transparent base sheet, and a peel-portion releasably adhered to the top surface of the base sheet by a transparent dry residue adhesive. The peel-portion is removable from the base sheet to reveal the underlying message. A plurality of game piece overlays can be provided on a wound roll of a carrier strip having a release surface to which the transparent base is adhered by the transparent pressure sensitive adhesive.

### CROSS REFERENCE TO RELATED APPLICATION

This is a divisional of U.S. patent application Ser. No. 12/411,580, filed on Mar. 26, 2009, which is incorporated herein by reference.

### FILED OF THE INVENTION

The present invention relates generally to promotional or gambling game pieces having a hidden or concealed message, and more particularly, relating to a novel game piece overlay structure for adhering to a surface of a game piece to conceal a message printed thereon, and a novel game piece using the same.

### BACKGROUND OF THE INVENTION

Promotional game pieces or gambling game pieces routinely comprise a sheet of card stock having printed thereon various advertising, promotional or decorative designs relating to the goods or services being promoted or relating the gambling game being played. In addition, there is one or more hidden messages, codes or designs printed, imprinted or otherwise provided on the game piece that a user must reveal in order to play the game presented by the game piece. There exists several different game piece constructions and methods which permit the concealing and then the revealing of a hidden message.

One existing construction and method provides an overlay of a material applied to the game piece to cover the message, which can later be scratched off to reveal the underlying message, this type of game piece is typically referred to as a scratch-off game piece. Drawbacks to scratch-off game pieces include requiring the user to have a suitable rigid object to scratch off the covering material, and the mess made by the covering material once it has been removed.

Another existing construction and method provides a two sheets of material of the same dimensions releasably laminated together. The first sheet of material or the bottom layer of the laminate has printed thereon any combination of advertising, promotional or decorative designs, and the message to be concealed and later revealed. The second of material or top layer also has printed thereon any combination of advertising, promotional or decorative designs. The second sheet of material is removed by a user to reveal the underlying bottom layer and the printed matter thereon, including the hidden message. This construction is typically referred to as a pull-sheet or a pull-tab game piece. Drawbacks to pull-sheet game pieces include the time consuming and expensive manufacturing process including the requirement to print two separate sheets of material that must be accurately registered together for laminating.

Accordingly, there is a need for new game piece overlay construction and game piece using the same that overcomes the above described and other drawbacks inherent with existing promotional or gambling game pieces having a hidden or concealed message.

### SUMMARY OF THE INVENTION

The preferred embodiments of the present invention addresses this need by providing a novel game piece overlay construction that is adhesively attachable to a pre-printed game piece to cover a message that is to be revealed by peeling back a strip portion of the game piece overlay, and by providing a game piece using the same.

The preferred embodiments of the present invention also provide a game piece overlay including a transparent sheet that is adhesively attachable to a pre-printed game piece to cover and protect a message that is to be revealed from tampering and unauthorized modification.

The preferred embodiments of the present invention further provide a game piece overlay construction that is easily manufactured using existing label manufacturing equipment.

The preferred embodiments of the present invention further provide a multiple game piece overlays on a wound carrier strip suitable for storage and easy dispensing of the game piece overlays.

To achieve these and other advantages, in general, in one aspect, an adhesive overlay for printed material is provided. The adhesive overlay includes a release layer having an adhesive release surface and a transparent base sheet having an upper surface and a lower surface coated with a transparent pressure sensitive adhesive. The transparent pressure sensitive adhesive releasably adheres the lower surface of the transparent base sheet to the release surface of the release layer. A top sheet coextensive with the transparent base sheet includes an upper surface, a lower surface, a peel portion and a non-peel portion. The non-peel portion being non-releasably adhered to the base sheet. A transparent dry residue adhesive releasably adheres the lower surface of the top sheet along the peel portion to the upper surface of the transparent base sheet. Wherein the transparent base sheet having the top sheet attached thereto is removable from the release layer and non-releasably attachable to an article thereon by the transparent pressure sensitive adhesive to at least partially conceal indicia printed on the article, and further wherein the concealed indicia is viewable through the transparent base sheet upon removal of the peel portion of the top sheet from the transparent base sheet.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying drawings, which are included to provide further understanding of the invention and are incorporated in and constitute a part of this specification, illustrate preferred embodiments of the invention and together with the description serve to explain the principles of the invention, in which:

FIG. 1 is a perspective view of a game piece incorporating the game piece overlay constructed in accordance with the principles of the present invention with the peel portion adhered to the transparent base sheet concealing an underlying message;

FIG. 2 is a cross-sectional view taken along line 2-2 in FIG. 1, illustrating the laminated construction of the game piece overlay, and the game piece overlay adhered to the game piece by the transparent pressure sensitive adhesive applied to the bottom surface of the transparent base sheet.

FIG. 3 is a perspective view of a game piece incorporating the game piece overlay of FIG. 1, illustrating the peel portion peeled away and revealing the underlying message that was previously concealed; and

FIG. 4 is a perspective view of a partial section of a carrier strip having adhered thereto a series of game piece overlays in accordance with an embodiment of the present invention.

### DETAILED DESCRIPTION OF THE INVENTION

The present invention relates to a game piece overlay that is adhesively attachable to an article to cover or conceal a code or message printed on the article, which can later be revealed by peeling a portion of the game piece overlay away. The game piece overlay is particularly useful in the manufacture of peel and win type game pieces, and as such reduces the complexity and cost of manufacturing peel and win game pieces.

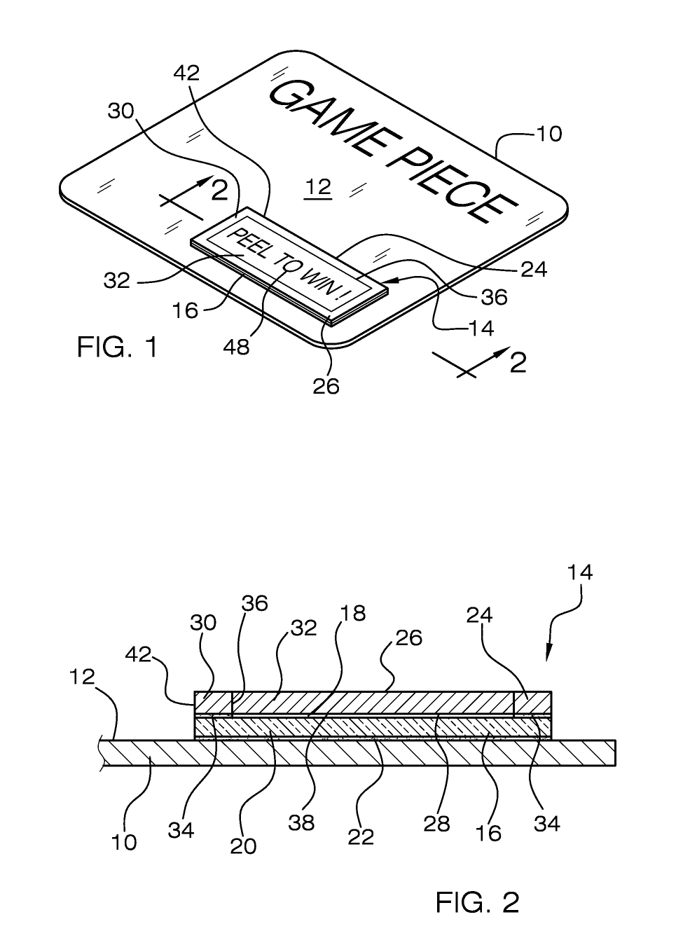

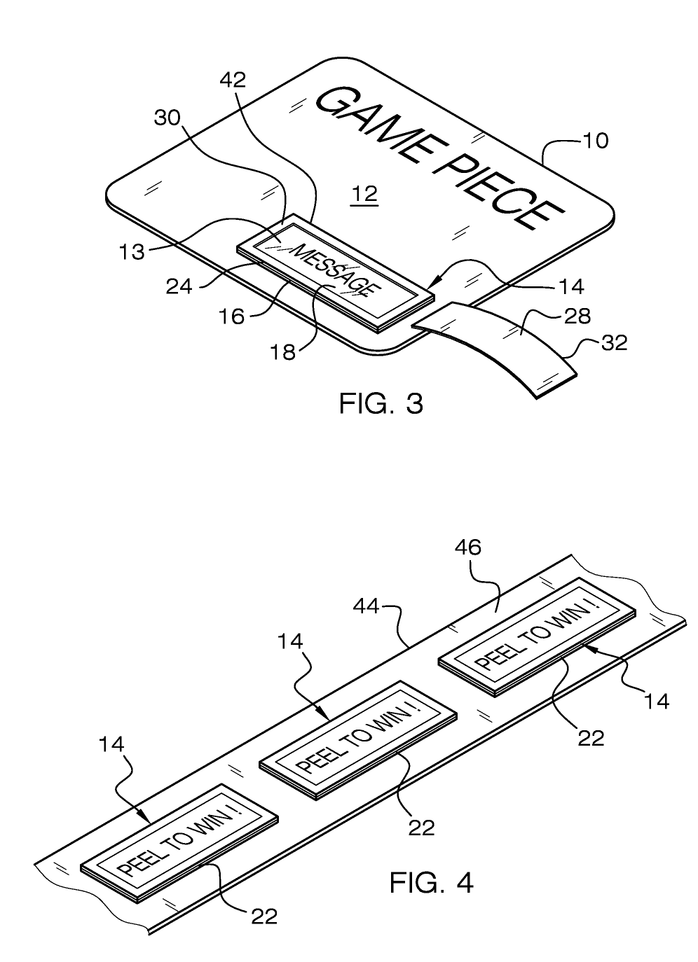

Referring now to the drawings, and more particularly to FIGS. 1-3, there is shown an article such as game piece card 10 having adhered to surface 12 thereof a game piece overlay 14 constructed in accordance with the principals of the present invention. Game piece overlay 14 is positioned on game piece card 10 to cover or conceal a message 13 or code printed on surface 12 that is to be later revealed, as best seen in FIG. 3. The game piece overlay includes a base sheet 16 having an upper surface 18 and a lower surface 20. The base sheet 16 is made of a transparent material such as, but not limited to clear acetate sheet material. The lower surface 20 of the base sheet 16 is substantially non-releasably adhered to surface 12 of the card 10 by an adhesive layer 22. The adhesive layer 22 is of transparent pressure sensitive adhesive that has been applied to the lower surface 20 of the base sheet 16. Preferably, the base sheet 16 is adhered to surface 12 with sufficient strength that the base sheet will remain attached to the surface during customary use, storage and transport of the game piece card 10.

A top sheet 24 coextensive with the base sheet 16 has an upper surface 26 and a lower surface 28, and is divided into a non-peel portion 30 and a peel portion 32 by die cut 36. The lower surface 28 of the top sheet 24 along the non-peel portion is non-releasably adhered to the upper surface 18 of the base sheet 16 by adhesive 34 or by other bonding methods. The lower surface 28 of the top sheet along the peel portion 32 is releasably adhered to the upper surface 18 of the base sheet 16 by a layer 38 of a transparent clean release adhesive having a selected adhesive strength. Layer 38 can be a water base clean release adhesive having a selected adhesive strength.

The term “clean release adhesive” as used herein shall refer to an adhesive that is residue free, dry and non-tacky when exposed by peeling away the peel portion 32. The phrases “clean release adhesive” and “dry residue adhesive” may be used herein interchangeably. The pressure sensitive adhesive 22, clean release adhesive 38, adhesive 34, base sheet 16, and top sheet 24 are so selected that the adhesion of the base sheet to the surface 12, and the adhesion of the non-peel portion 30 of the top sheet to the base sheet is greater than the adhesion of the peel portion 32 of the top sheet to the base sheet. Consequently, the peel portion 32 of the top sheet 24 may be removed from the base sheet 16 without tearing or otherwise destroying either sheet and without removing the base sheet from the surface 12.

As best seen in FIG. 1, the non-peel portion 30 spans continuously around and between the peripheral edge 42 of the top sheet 24 and an interior edge 50 of the non-peel portion and forms a border or frame around the peel portion 32. The non-peel portion 30 protects the edges of the peel portion 32 from undesired contact and being inadvertently peeled from the base sheet 16. Protecting the peel portion 32 is particularly important in the situation when a promotional piece or game piece is distributed with the game piece overlay 14 exposed to physical contact with the surroundings and/or other material being distributed with the game piece, for example, by mail.

In one embodiment, the peel portion 32 is free from connection with the non-peel portion 30, and can be completely separated from the game piece overlay 14 when peeled away from the base sheet 16, as best seen in FIG. 3. The top sheet 24 can be separated or divided into the non-peel portion 30 and the peel portion 32 by a cut pattern 36 made centrally on the top sheet, for example by a die cutting machine during manufacture.

The game piece overlay 14 can be provided with the upper surface 26 of the top sheet 24 including an identify message or indicia 48 providing instruction to a user to peel back peel portion 32 to reveal the underlying hidden message or code.

The top sheet 24 of the game piece overlay 14 is made of an opaque material. Thus, when the game piece overlay 14 is placed on a game piece to conceal indicia on the game piece, the indicia is not visible through the top sheet 24. Most preferably, the top sheet 24 is made of an opaque and non-translucent material such backlight of the game piece will not reveal or make the concealed indicia underlying the game piece overlay readily visible through the top sheet.

Alternatively, the top sheet 24 can include a coating or other application which prevents viewing of the underlying indicia until the peel portion 32 is removed.

With reference to FIG. 4, there is shown a partial section of a release layer or carrier strip 44 having an adhesive release surface 46, and bearing a series of game piece overlays 14 removably adhered to the release surface by adhesive layer 22. The release surface 46 is such that the adhesive layer 22 adheres to the web 44 less strongly than the lower surface 20 of the base sheet 16, thereby permitting a game piece overlay 14 to be easily peeled from the web and applied to a game piece. Multiple game piece overlays 14 can be constructed and provided on web 44 using conventional and known label laminating and die cutting methods and machines. It is to be understood, while it is shown, as several game piece overlays 14 attached to a single release surface of carrier strip 44, a game piece overlay 14 can be provided separately with a release layer.

In use, it can now be understood, a plurality of game pieces for a particular game can be preprinted with codes or messages thereon to be concealed for future game play using conventional methods known in the art. The codes or message printed on each game piece are easily concealed by peeling a game piece overlay 14 from the carrier strip 44 and positioning the game piece overlay over the code or message to be covered. Sufficient pressure is then applied to the game piece overlay 14 to adhere pressure sensitive adhesive 22 to the surface of the game piece. Thereafter, the game pieces can be distributed to end users. The end user can then reveal the hidden message or code by peeling the peel portion 32 of the top sheet 24 from the base sheet 16 and viewing the hidden message of code through the transparent base sheet.

A number of embodiments of the present invention have been described. Nevertheless, it will be understood that various modifications may be made without departing from the spirit and scope of the invention. Accordingly, other embodiments are within the scope of the following claims.

What is claimed is:

1. A game piece assembly having concealed indicia, the assembly comprising:
an article having indicia printed on a surface;
a transparent base sheet having an upper surface and a lower surface;
a transparent adhesive applied to said lower surface of said transparent base sheet non-releasably adhering said transparent base sheet to said article over a portion of said indicia;
a top sheet having an upper and a lower surface, said top sheet being coextensive with said transparent base sheet, said top sheet having a peel portion and a non-peel portion, said non-peel portion being non-releasably adhered to said base sheet;
a transparent dry residue adhesive between said upper surface of said transparent base sheet and said lower surface of said top sheet along said peel portion releasably adhering said peel portion of said top sheet to said upper surface of said transparent base sheet, wherein the portion of indicia covered by said transparent base sheet is viewable through said transparent base sheet upon removal of said peel portion of said top sheet from said transparent base sheet.

2. The assembly of claim 1, wherein said article is sheet of card stock.

3. The assembly of claim 1, wherein said non-peel portion is non-releasably adhered to said upper surface of said base sheet.

4. The assembly of claim 1, wherein said peel portion of said top sheet being positioned interiorly of said non-peel portion.

5. The assembly of claim 1, wherein said peel portion is free from attachment with said non-peel portion.

6. The assembly of claim 1, wherein said non-peel portion spans continuously between a peripheral edge of said top sheet and an interior edge of said non-peel portion;
and said peel portion having a peripheral edge extending along said interior edge of said non-peel portion.

7. The assembly of claim 6, wherein said peripheral edge of said peel portion continuously extends along said interior edge of said non-peel portion.

8. The assembly of claim 1, wherein said top sheet includes a centrally located cut pattern dividing said top sheet into said non-peel portion and said peel portion, wherein the portion of said top sheet located on the interior of said cut pattern provides said peel portion and the portion of said top sheet exterior of said cut pattern provides said non-peel portion.
